(19) United States
(12) Patent Application Publication
(10) Pub. No.: US 2002/0158898 A1
(43) Pub. Date: Oct. 31, 2002

(54) Graphical user interfaces for viewing and configuring devices in an automated provisioning environment

(76) Inventors: Vivian G. Hsieh, Santa Clara, CA (US); Joshua Atir, Sunnyvale, CA (US); Anne Ustach, Oakland, CA (US)

Correspondence Address: James A. LaBarre, BURNS, DOANE, SWECKER & MATHIS, L.L.P, P.O. Box 1404, Alexandria, VA, 22313-1404, US

(21) Appl. No.: 09/843,767

(22) Filed: Apr. 30, 2001

(51) Int. Cl. G09G 5/00

(52) U.S. Cl. 345/736

(57) ABSTRACT

A graphical user interface for viewing and configuring devices in one or more data centers and associated with different customer infrastructures is described. The interface provides the user with a series of informational screens which rapidly provide the significant device configuration information which will be of interest to operations personnel. Additionally, graphical user interfaces according to the present invention provide techniques for rapid and repeatable installation and updating of operating system, application and customer software.

### FIELD OF THE INVENTION

The present invention is directed to graphical user interfaces generally and, more particularly, to graphical user interfaces which provide for the provisioning of servers and other computing devices that provide support for sites that are hosted on the Internet, intranets, and other communication networks.

### BACKGROUND OF THE INVENTION

The growing popularity and increasing accessibility of the Internet has resulted in its becoming a major source of information, as well as a vehicle for inter-party transactions, in a variety of environments. For instance, a number of different types of entities, such as government agencies, school systems and organized groups, host Internet and/or intranet web sites that provide informational content about themselves and topics related to their interests. Similarly, commercial enterprises employ web sites to disseminate information about their products or services, as well as conduct commercial transactions, such as the buying and selling of goods. To support these activities, each web site requires an infrastructure at one or more centralized locations that are connected to a communications network, such as the Internet. Basically, this infrastructure stores the informational content that is associated with a particular site, and responds to requests from end users at remote locations by transmitting specific portions of this content to the end users. The infrastructure may be responsible for conducting other types of transactions appropriate to the site as well, such as processing orders for merchandise that are submitted by the end users. A significant component of this infrastructure is a web server, namely a computer having software which enables it to receive user requests for information, retrieve that information from the appropriate sources, and provide it to the requester. Web sites which provide more complex services, such as online ordering, may also include application servers to support these additional functions.

In the case of a relatively small entity, the infrastructure to support its web site may be as simple as a single server, or even a portion of a server. Conversely, a large, popular web site that contains a multitude of content and/or that is accessed quite frequently may require numerous web servers to provide the necessary support. Similarly, web sites for commercial entities, via which transactional operations are conducted, may employ multiple application servers to support transactions with a large number of customers at one time. In addition to servers, the infrastructure for a web site typically includes other types of computing devices such as routers, firewalls, load balancers and switches, to provide connectivity, security and efficient operation.

In addition to the hardware components associated with a web site's infrastructure, a number of software components are also typically involved therewith. The term “provisioning” is used herein to refer to, among other things, the installation of the software that is executed by the device to perform the functions assigned to it, and the subsequent configuration of that software to optimize its operation for the given site. Such provisioning initially occurs when the web site is launched, i.e. when one or more servers are connected to an appropriate communications network such as the Internet, and loaded with the programs and data content necessary to provide the services associated with the site. Thereafter, a need for further provisioning may arise, particularly in the case of a successful web site, when additional servers must be added to support an increasing number of requests from end users. In another instance, the provisioning of the servers and other computing devices may be required as part of a disaster recovery operation, for example a sudden interruption in power, an attack by a hacker, or corruption of stored software and/or data.

The provisioning of a server or other device that supports the operation of a web site involves several discrete steps. First, the appropriate operating system software must be loaded onto the device. Thereafter, software applications that are required to support the particular functions or services associated with the site are loaded, such as database software, credit card processing software, order processing software, etc. After they have been loaded, these applications may need to be configured, e.g. their operating parameters are set to specific values, to support the requirements of the particular site and/or optimize their performance for that site. Finally, the content associated with the individual pages of the web site must be loaded, after which further configuration may be required. The order in which these various components are loaded onto the server and configured can be quite critical, to ensure compatibility of the various programs with one another.

In the past, the hardware arrangements and interconnections, as well as the provisioning of web servers, was often carried out and annotated manually. In other words, each item of software was individually loaded onto the server and then configured by a person having responsibility for that task. The hardware interconnectivity was frequently ad hoc and occasionally poorly documented. One problem with such an approach is the fact that it consumes a significant amount of time. For a relatively large site that is supported by multiple servers, the provisioning could take several days to be completed, thereby delaying the time before the site can be launched and/or upwardly scaled to accommodate increasing traffic. Another, and perhaps more significant, limitation associated with the manual provisioning of devices is the lack of repeatability in the software configurations. More particularly, whenever manual operations are involved in the installation of software, there is always the possibility of human error, such as the failure to install one of the required components, or the loading of the various items of software in the wrong order. Such errors can result in misoperation or total failure of the web site, and can be extremely time consuming to discover and correct.

In addition, when a configuration adjustment is made on one device to improve its performance, if that change is not recorded by the person making the adjustment, it may not be carried over to subsequent devices of the same type when they are provisioned. This latter problem is particularly acute if a device should experience a failure a considerable period of time after the given device was configured. If the person who was responsible for originally configuring the device is no longer available, e.g. he or she has left the employ of the company hosting the site, it may not be possible to reconstruct the original configuration if it was not recorded at the time it was implemented. The same concerns arise if the site needs to be upwardly scaled by adding more devices of the same type after the employee has left.

To overcome some of the problems associated with the installation of software on multiple computers, various techniques have been developed which permit software to be automatically deployed to the computers with minimum involvement by humans. However, these techniques are limited in the types of environments in which they can be utilized. For example, in an enterprise where all of the users interact with the same legacy applications, a “cookie cutter” type of approach can be used to deploy the software. In this approach, every computer can have the same, standard set of programs, each with the same configuration. Once the software programs and settings have been determined, they can be packaged in a fixed format, sometimes referred to as a “ghost” or “brick”, and automatically disseminated to all of the appropriate computers. Thus, whenever a change is made to the standard configuration, it can be easily distributed to all of the users at once. Similarly, if a particular user experiences a failure, for instance due to a computer virus, the standard package can be readily installed on the user's computer, to restore the original functionality.

However, this type of automated deployment is not effective for situations in which computers, such as servers, need to be customized to accommodate the individual requirements of varied users. One example of such a situation is a data center which may house the infrastructure for hundreds of different web sites. The hardware and software requirements for these sites will typically vary among each site. For instance, each site will likely have a different business logic associated with it, i.e. the informational content and services associated with a given site will not be the same as those of any other site supported by that data center. These differences may require a combination of hardware and software which is unlike that of any other site. Similarly, different web site developers may employ different platforms for the sites, thereby necessitating various combinations of operating systems and application programs on the servers of the respective sites. Furthermore, different types of equipment may be utilized for the sites, thereby adding to the complexity of the provisioning process. In some cases, the same site may require a variety of different hardware devices, operating systems and application programs to handle all of the different services provided by that site. For an entity that is responsible for managing the varied infrastructure of these sites, such as a data center operator or a third-party infrastructure utility provider, the known approaches to automated software deployment are not adapted to meet the high degree of customization that prevails in these types of situations. Rather, because of the flexibility that is required to accommodate a different configuration of hardware and/or software for each site, manual provisioning is still being practiced to a large extent, with all of its attendant disadvantages.

An exemplary framework for the automated provisioning of servers and other devices that support various types of network-based services, such as the hosting of an Internet or intranet web site, is described in U.S. patent application Ser. No. 09/699,329, entitled “Automated Provisioning Framework For Internet Site Servers” to Raymond Suorsa, filed on Oct. 31, 2000. The present invention relates to graphical user interfaces which provide high level mechanisms by way of which site provisioning and configuration can be implemented in a repeatable and well-documented manner and which permits system operators to obtain, e.g., configuration, information associated with provisioned infrastructures.

### SUMMARY OF THE INVENTION

According to exemplary embodiments of the present invention, these and other drawbacks and limitations of conventional systems are overcome by graphical user interfaces for viewing and configuring devices in one or more data centers and associated with different customer infrastructures. Exemplary interfaces provide the user with a series of informational screens which rapidly provide the significant device configuration information which will be of interest to operations personnel. Additionally, graphical user interfaces according to the present invention provide techniques for rapid and repeatable installation and updating of operating system, application and customer software.

According to one exemplary embodiment, a graphical user interface according to the present invention includes a first user interface element actuable to access a first portion of said graphical user interface, which first portion displays information associated with a plurality of devices that correspond to a customer, and a second user interface element actuable to access a second portion of said graphical user interface, which second portion displays information and configuration user interface elements for the devices. Devices in this context includes, but is not limited to, servers, firewalls, load balancers and switches.

These and other features of the invention are explained in greater detail hereinafter with reference to an exemplary embodiment of the invention illustrated in the accompanying drawings.

### BRIEF DESCRIPTION OF THE DRAWINGS

FIG. 1 is a block diagram of the basic logical tiers of a web site;

FIGS. 2a and 2b are more detailed diagrams of the devices in an exemplary web site;

FIG. 3 is a block diagram of one exemplary embodiment of the hardware configuration for a web site in a data center;

FIG. 4 is a general block diagram of a data center in which the infrastructures having devices that are viewed and configured using graphical user interfaces according to the present invention can be implemented;

FIG. 5 is a block diagram of an exemplary provisioning framework which interacts with graphical user interfaces in accordance with the principles of the invention;

FIG. 6 depicts a main menu of a graphical user interface according to an exemplary embodiment of the present invention;

FIGS. 7a and 7b depict portions of a graphical user interface for viewing devices in accordance with exemplary embodiments of the present invention;

FIGS. 8a-8j 5depict portions of a graphical user interface for configuring devices in accordance with exemplary embodiments of the present invention;

FIGS. 9a-9c depict portions of a graphical user interface for searching for devices in accordance with exemplary embodiments of the present invention; and

FIGS. 10a-10b depict portions of a graphical user interface for test reconciliation in accordance with exemplary embodiments of the present invention.

### DETAILED DESCRIPTION

To facilitate an understanding of the principles of the present invention, it is described hereinafter with reference to its application in the provisioning of devices that support web site operations, such as servers, load balancers, firewalls, and the like. Further in this regard, such description is provided in the context of a data center, which typically accommodates the infrastructure to support a large number of different web sites, each of which may have a different configuration for its infrastructure. It will be appreciated, however, that the implementation of the invention that is described hereinafter is merely exemplary, and that the invention can find practical application in any environment where the automated provisioning of computer resources is desirable. Thus, for example, the principles which underlie the invention can be employed to provision computing devices in the networks of an enterprise, or in any other situation in which there are a sufficient number of computing devices to realize the benefits of automated provisioning.

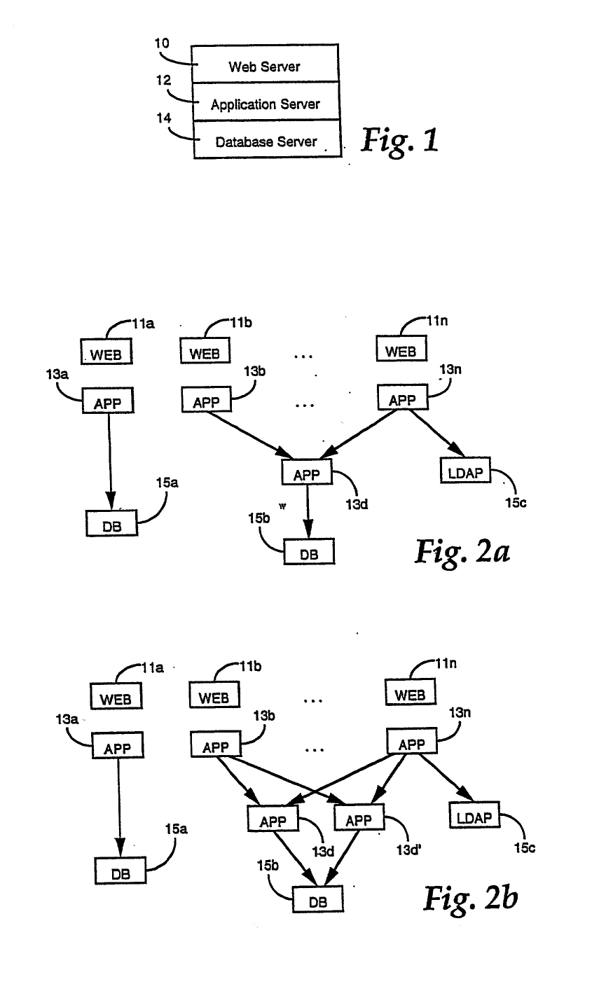

Prior to discussing the specific features of exemplary embodiments of the invention, a general overview of the infrastructure for hosting a web site will first be provided. Fundamentally, a web site can be viewed as consisting of three functional tiers. Referring to FIG. 1, one tier comprises a web server tier 10. The web server is the combination of hardware and software which enables browsers at end user locations to communicate with the web site. It performs the task of receiving requests from end users who have connected to the web site, such as HTTP requests and FTP requests, and delivering static or dynamic pages of content in response to these requests. It also handles secure communications through a Secure Socket Layer (SSL), and the generation of cookies that are downloaded to browsers. Typically, since these types of operations do not require a significant amount of processing power, the web server can operate at relatively high volume rates. The throughput capacity of this tier is usually determined by the amount of server memory and disk storage which is dedicated to these operations.

Another tier of the web site comprises an application server tier 12. This component performs dynamic transactions that are much more computationally intensive, such as order processing, credit card verification, etc. Typically, the application server implements the development environment that defines the business logic and presentation layer associated with a given site, i.e. its functionality as well as its “look and feel”. The performance of this tier is normally determined by the amount of CPU processing power that is dedicated to it. Separation of the web servers and the application servers into different tiers ensures reliability and scalability.

The third tier of the site comprises a database tier 14. This tier stores information relevant to the operation of the site, such as customer demographic and account information, available stock items, pricing, and the like. Preferably, it is implemented with a relational database architecture, to permit the data to be manipulated in a tabular form. Connection pooling to the database can be performed by the application servers, to minimize redundant calls and thereby preserve processing power.

While the fundamental architecture of a web site can be viewed as comprising these three tiers, in an actual implementation the structure of the web site can be significantly more complex. Depending upon the size and requirements of the site, in some cases the database tier can be combined into the application server tier. Even more likely, however, is an architecture in which one or more tiers is divided into several layers. This occurrence is particularly true for the application server tier, because it implements the business logic of a site. Depending upon the types of transactions to be performed by the site, the application server tier may require a number of different types of specialized application servers that are interconnected in various ways. One example of such is depicted in FIG. 2a. In this situation, the site includes a number of web servers 11a, 11b, . . . 11n. Each of these web servers may have the same software and same configuration parameters. The site also includes a number of application servers 13a, 13b, . . . 13n. In this case, however, not all of the application servers are the same. For instance, server 13a communicates with a first type of database server 15a, whereas servers 13b and 13n communicate with another application server 13d at a different level, which may be a highly specialized server. This server may communicate with a second type of database server 15b to carry out the specialized services that it provides. In addition, the server 13n may communicate with a directory server 15c.

If the performance of the server 13d begins to degrade due to increased traffic at the web site, it may be necessary to add another server 13d′, to provide additional CPU capacity, as depicted in FIG. 2b. However, because of the architecture of the site, the automated provisioning task becomes more complex, since the application server 13d is different from the other application servers 13a, 13b, etc., in both its configuration and its connection to other devices. Hence, not all of the application servers can be treated in the same manner. Furthermore, since the business logic of a given site is likely to be different from that of other sites, the configuration parameters that are employed for the site of FIG. 2a may not be appropriate for the devices of any other site, which increases the complexity of the provisioning process even more.

In many instances, the infrastructure for supporting a web site is housed in a data center, which comprises one or more buildings that are filled with hundreds or thousands of servers and associated equipment, for hosting a large number of different web sites. Typically, each floor of the data center contains numerous rows of racks, each of which accommodate a number of servers. In one configuration, each web site may be assigned a portion of a server, or portions of several servers, depending upon its requirements. This approach is typically employed by Internet service providers (ISPs), and is referred to as a “multi-tenancy” configuration, wherein multiple sites may be resident on a given server.

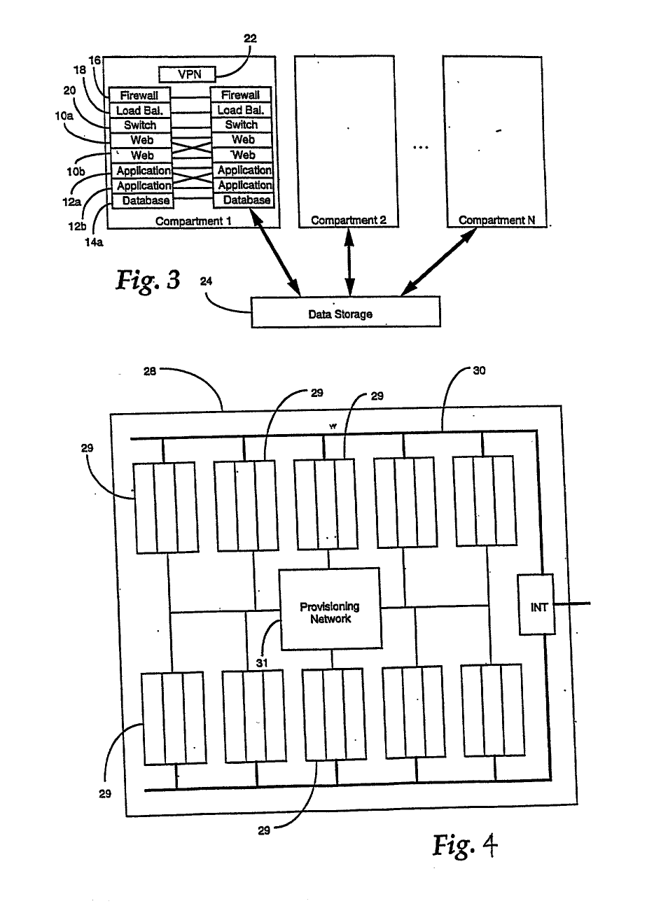

In an alternate configuration, each site is allocated a discrete compartment within the data center, with the servers and other computing devices within that compartment being dedicated to hosting the services of the given site. FIG. 3 is a block diagram illustrating this latter configuration. This figures illustrates three exemplary web site compartments, each of which accommodates the equipment for hosting a web site. Thus, in the illustrated embodiment, each compartment includes one or more web servers 10a, 10b, one or more application servers 12a, 12b, and a database server 14a, to provide the three functional tiers. In addition, the components of the web site infrastructure may include a firewall 16 to provide security against attacks on the site, a load balancer 18 for efficient utilization of the web servers and the application servers, and a switch 20 for directing incoming data packets to the appropriate servers. These devices in the web site compartment can be securely connected to the host entity's computer system via a virtual private network 22. To avoid a single point of failure in the web site, additional redundant components are included, and like components are cross-connected with one another. This feature of redundancy and cross-connection adds another layer of complexity to the automated provisioning process, particularly as the web site grows so that the number of devices and their cross-connections increase and become more complicated to manage.

The physical storage devices for storing the data of a web site can also be located in the compartment, and be dedicated to that site. In some cases, however, for purposes of efficiency and scalability, it may be preferable to share the data storage requirements of multiple compartments among one another. For this purpose, a high capacity storage device 24 can be provided external to the individual compartments. When such a configuration is employed, the storage device 24 must be capable of reliably segregating the data associated with one compartment from the data associated with another compartment, so that the different hosts of the web sites cannot obtain access to each others' data. Examples of storage devices which meet these requirements are those provided by EMC Corporation of Hopkinton, Mass. For additional discussion of the manner in which devices of this type can be incorporated into an infrastructure such as that depicted in FIG. 3, reference is made to U.S. patent application Ser. No. 09/699,351, filed on Oct. 31, 2000, entitled “A Data Model For Use In The Automated Provisioning of Central Data Storage Devices”, the disclosure of which is incorporated herein by reference.

One feature of the present invention comprises graphical user interfaces and methods associated with the use of such interfaces for automating the configuration and maintenance of servers during the entirety of their life cycles, i.e., from the beginning of the provisioning process until such time in the future as the servers are decommissioned. Further in this regard, an objective of the invention is to provide graphical user interfaces for deploying and configuring a large number of servers and associated devices within one or more data centers, that may be associated with different respective web sites, and therefore have different provisioning and interconnectivity requirements.

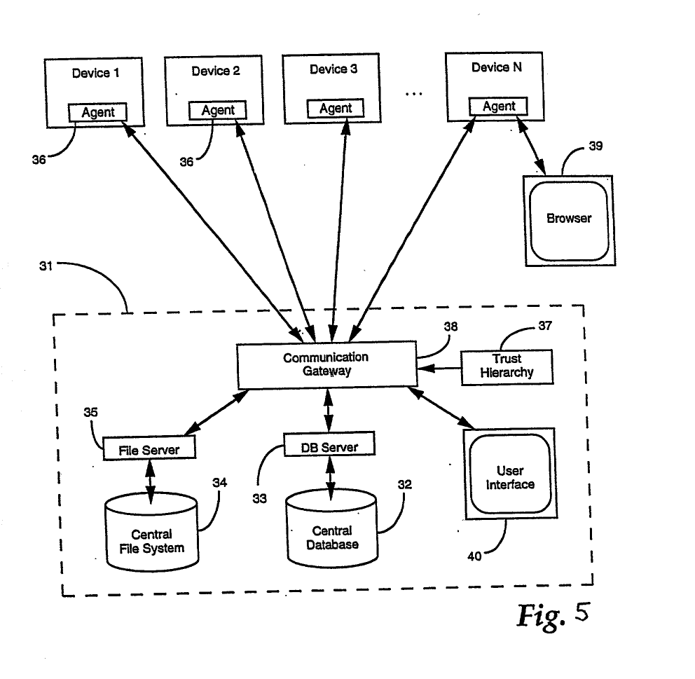

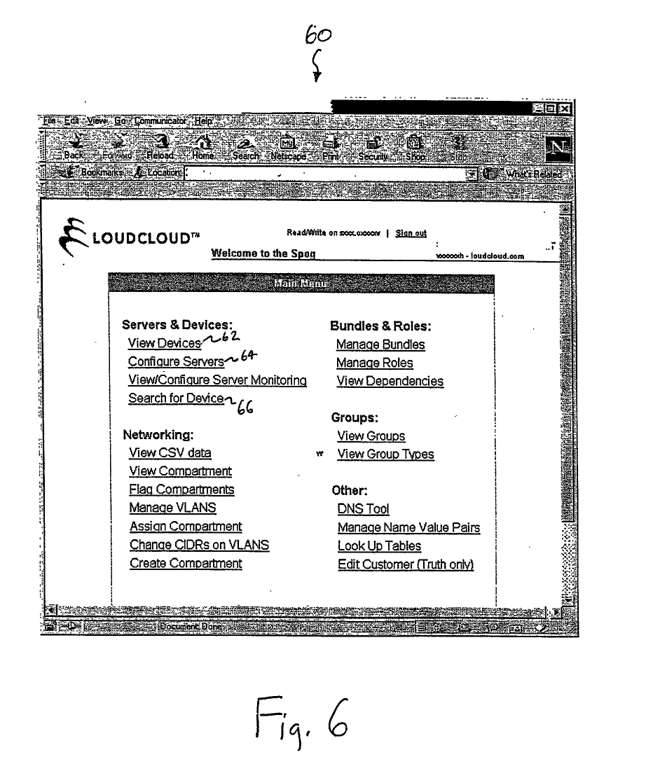

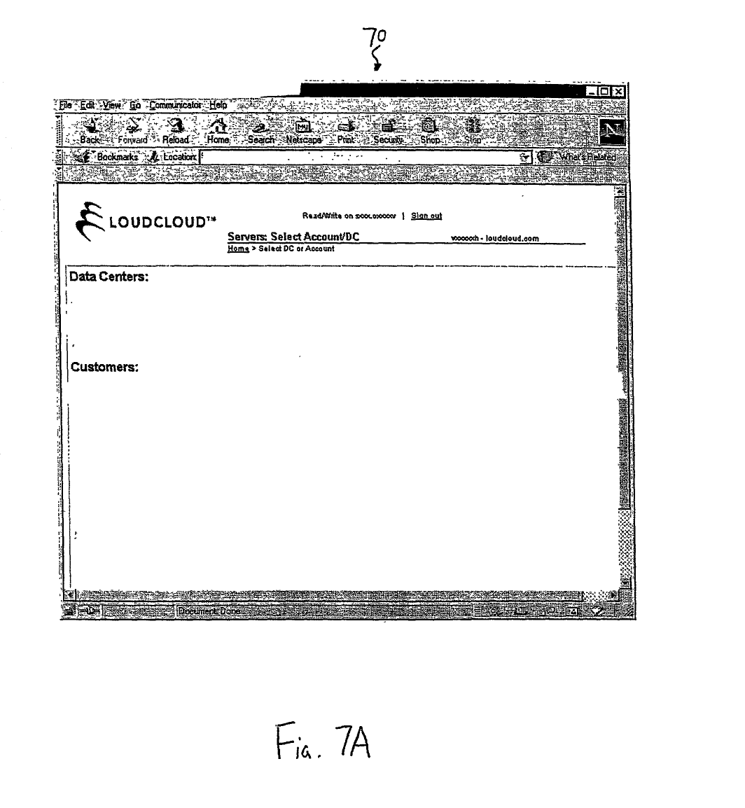

An overview of one environment in which the present invention operates is depicted in FIG. 4. A data center 28 is partitioned into multiple customer compartments 29, each of which may be arranged as shown in FIG. 3. Each compartment is connected to a backbone 30 or similar type of common communication line for access by computers which are external to the data center. For instance, if the compartments are associated with Internet web sites, the backbone 30 constitutes the physical communication path via which end users access those sites over the Internet. The backbone may also form the path via which the web site hosts can securely communicate with the devices in their individual compartments, for instance by virtual private networks.

Also located in the data center 28 is a provisioning and management network 31. This network may be located within another compartment in the data center. This network is connected to the computing devices in each of the compartments 29 which are to be managed. In the embodiment of FIG. 4, the provisioning network 31 is illustrated as being connected to the compartments 29 by a network which is separate from the backbone 30. In an alternative implementation, the provisioning network can communicate with the compartments over the backbone, using a secure communications protocol.

The provisioning network 31 may be operated by the owner of the data center, or by a third-party infrastructure utility provider. While FIG. 4 illustrates all of the compartments being connected to the network 31, this need not be the case. To this end, multiple provisioning networks may be located in the data center, with each one operated by a separate entity to provision and manage the devices in different ones of the compartments 29.

To automate the provisioning of servers and related types of devices in accordance with this exemplary provisioning framework, an agent can be installed on each device that is controlled by the network 31, to handle the retrieval and loading of software onto the device. The agent communicates with the provisioning network 31 to obtain commands regarding tasks that need to be performed on its device, as well as obtain the software components that are to be installed as part of the provisioning process. For more details regarding exemplary agents and their operation in automated provisioning systems, the interested reader is referred to U.S. patent application Ser. No. 09/699,354, filed on Oct. 31, 2000, entitled “Automated Provisioning Framework for Internet Site Servers”, the disclosure of which is incorporated here by reference.

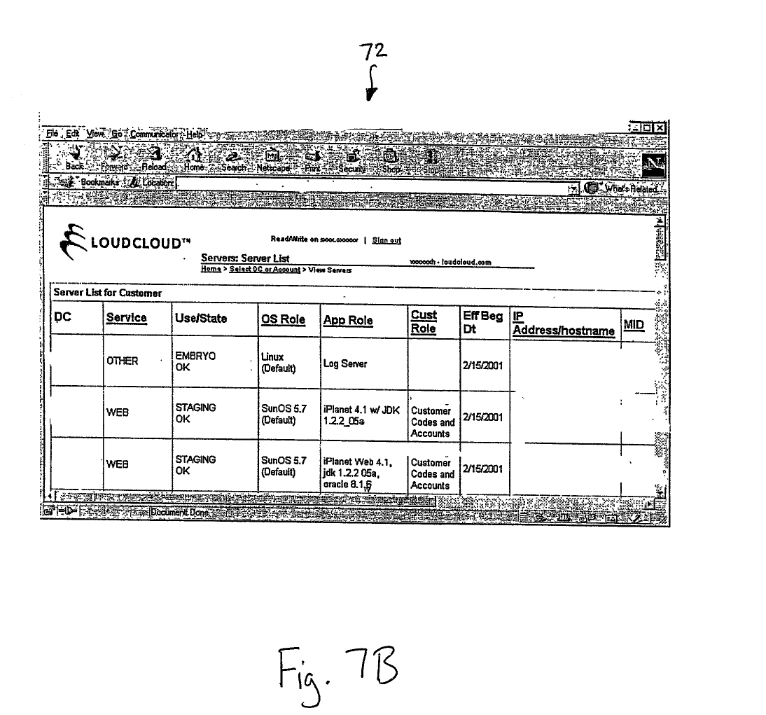

One example of a provisioning network 31 that communicates with the agents on individual devices, to perform automated provisioning, is illustrated in FIG. 5. Two fundamental functions are implemented by the provisioning network. One of these functions is to maintain information about, and manage, all of the devices that are associated with the provisioning system. The second function is to store and provide the software that is loaded on these devices. The first function is implemented by means of a central database 32, that is accessed via a database server 33. This database comprises a repository of all pertinent information about each of the devices that are connected to the provisioning network. Hence, depending upon the extent of the provisioning system, the central database might contain information about devices in only a few web site compartments, or an entire data center, or multiple data centers. The information stored in this database comprises all data that is necessary to provision a device. For instance, it can include the hardware configuration of the device, e.g., type of processor, amount of memory, interface cards, and the like, the software components that are installed on the device along with the necessary configuration of each of those components, and logical information regarding the device, such as its IP address, the web site with which it is associated, services that it performs, etc. For a detailed discussion of an exemplary model of such a database for storing all of the relevant information, reference is made to U.S. patent application Ser. No. 09/699,353, filed on Oct. 31, 2000, the disclosure of which is incorporated herein by reference. In essence, the information stored in the database constitutes a model for each device that is managed by the provisioning system, as well as the interconnection of those devices.

The second principal function of the provisioning network is implemented by means of a central file system 34, which is accessed via a file server 35. This file system stores the software that is to be installed on any of the devices under the control of the provisioning system. To facilitate the retrieval of a given item of software and forwarding it to a destination device, the software components are preferably stored within the file system as packages. One example of a tool that can be used to create software packages for a Linux operating system is the Red Hat Package Manager (RPM). This tool creates packages in a format that enables the contents of a package, e.g. the files which constitute a given program, to be readily determined. It also includes information that enables the integrity of the package to be readily verified and that facilitates the installation of the package, i.e., by including installation instructions that are built in to the RPM package. To support a different operating system, a packaging tool appropriate to that operating system, such as Solaris Packages for Sun operating systems or MSI for Microsoft operating systems, can also be employed. Regardless, all packages for all operating systems can be stored in the file system 34.

In operation, when the automated provisioning of a device is to be performed, a command is sent to an agent 36 on the device, instructing it to obtain and install the appropriate software. The particular software components to be installed are determined from data stored in the central database 32, and identified in the form of a Uniform Resource Location (URL), such as the address of a specific package in the file system 34. Upon receiving the address of the appropriate software, the agent 36 communicates with the central file system 34 to retrieve the required packages, and then installs the files in these packages onto its device. The commands that are sent to the agent also instruct it to configure the software in a particular manner after it has been loaded. Commands can also be sent to the agent to instruct it to remove certain software, to configure the network portion of the operating system, or to switch from a dynamically assigned network address to one which is static. To further enhance the security of the communications between the provisioning network and the agents, the network includes a central gateway 38 for communications.

There may be situations in which it is desirable to permit personnel who do not have access to the provisioning system per se to communicate with the agents. For instance, IT personnel at the entity hosting the site may need to perform some types of operations through the agent. In this case, the agent can be given the ability to communicate with a computer 39 external to the network, for instance by means of a browser on that computer. This external access can also serve as a debugging mechanism. For instance, a new configuration can be set up on a device and then tested in isolation on that device, via the browser, before it is deployed to all of the other devices of that same type. Whenever access to a device is sought by an entity outside of the secure network 28, the agent communicates with the gateway 38 to check with the trust hierarchy 37 and first confirm that the entity has the authority to access the device.

Another component of the provisioning system is a user interface 40 by which the devices are managed. The user interface 40 communicates with the gateway 38, which converts messages into the appropriate format. For instance, the gateway can convert SQL data messages from the database 32 into an XML (Extensible Markup Language) format which the user interface 40 then processes into a presentation format for display to the user. Conversely, the gateway converts procedure calls from the user interface into the appropriate SQL statements to retrieve and or modify data in the database 32. For a detailed description of one technique for performing such a conversion, reference is made to U.S. patent application Ser. No. 09/699,349, filed on Oct. 31, 2000, entitled “Object Oriented Database Abstraction and Statement Generation”, the disclosure of which is incorporated herein by reference.

In essence, the user interface 40 comprises a single point of entry for establishing the policies related to the management of the devices. More particularly, whenever a change is to be implemented in any of the devices, the device is not directly configured by an operator. Rather, through the user interface, the operator first modifies the model for that device which is stored in the database. Once the model has been modified, the changes are then deployed to the agents for each of the individual devices of that type from the data stored in the database, by means of the gateway 38. Preferably, the version history of the model is stored as well, so that if the new model does not turn out to operate properly, the device can be returned to a previous configuration that was known to be functional. The different versions of the model can each be stored as a complete set of data, or more simply as the changes which were made relative to the previous version.

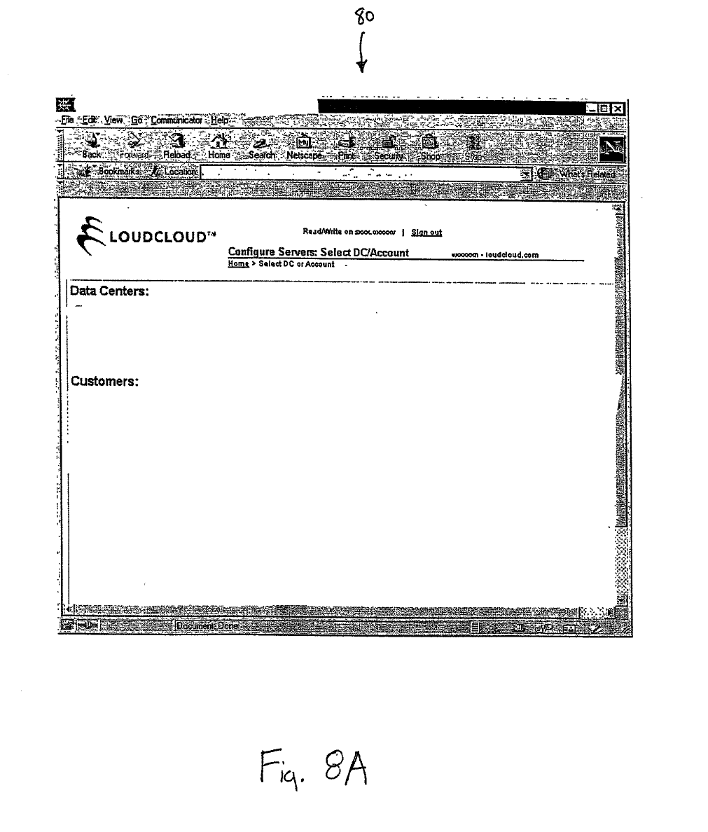

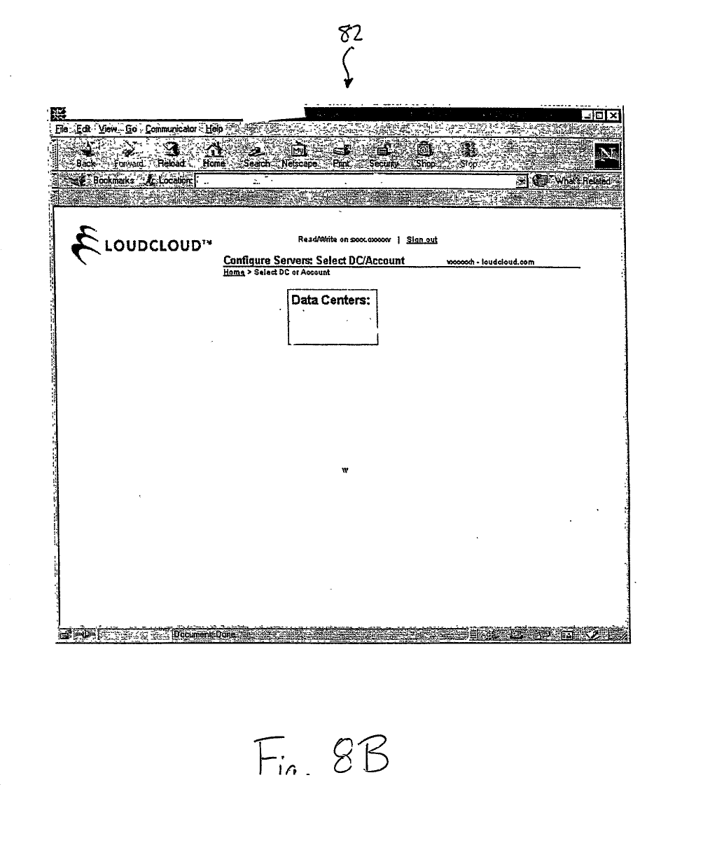

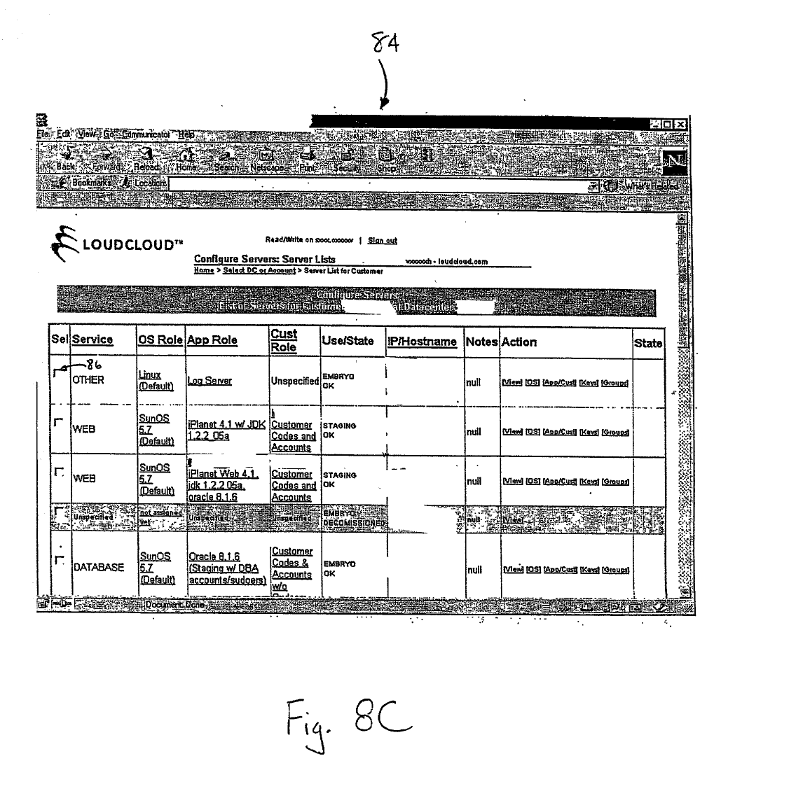

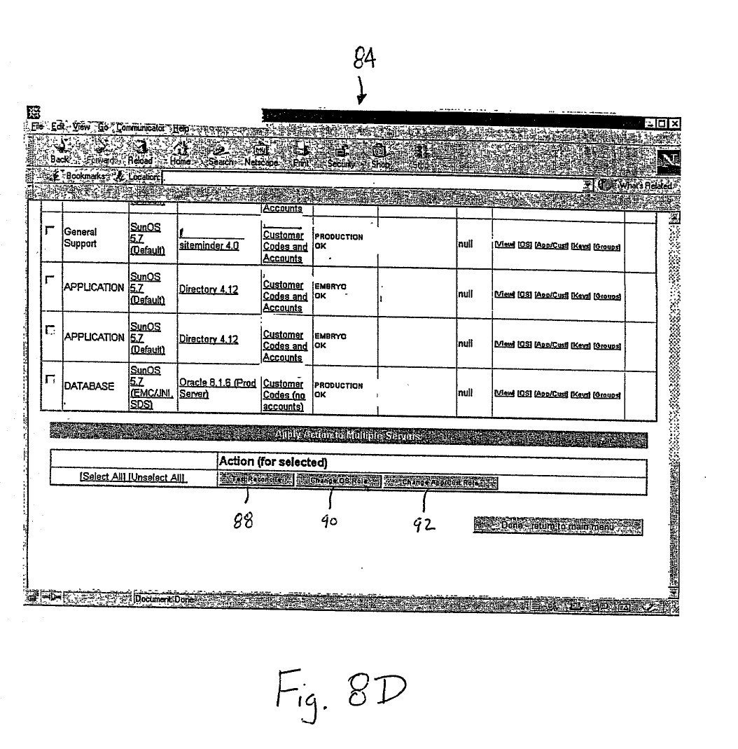

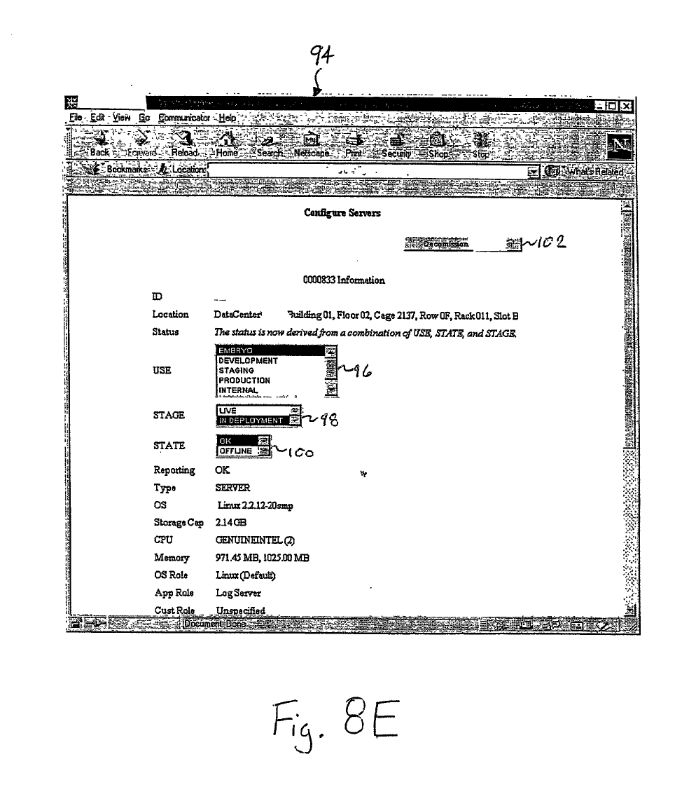

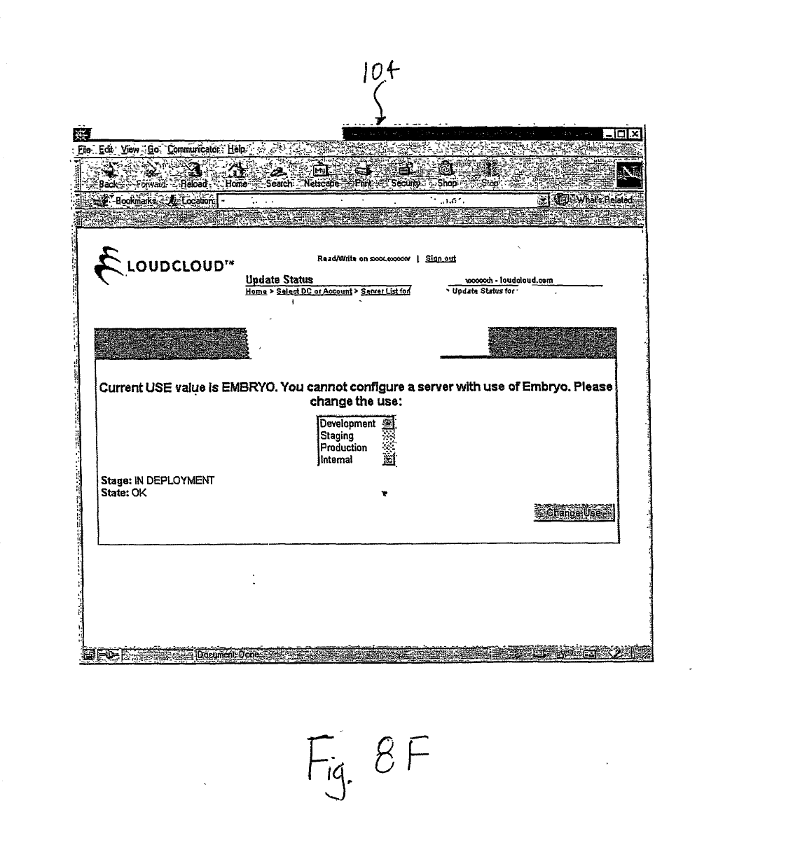

An exemplary user interface according to the present invention will now be described with respect to FIGS. 6-9C. In FIG. 6, a main menu screen 60 associated with the user interface 40 is illustrated. Although this exemplary embodiment of a graphical user interface (GUI) according to the present invention is described in the context of a hierarchical, menu style GUI, those skilled in the art will appreciate that other user interface techniques could also be used to provide the same interface functionality. Therein, a plurality of links are provided for the user's selection to perform various interactions with the provisioning system, e.g., that described above, and/or to gather information associated with the provisioning system and the provisioned infrastructure. Although a user can select any of the illustrated links, in any order to access the lower hierarchical menus, this description will discuss the linked screens, and their associated functionality, in the order listed in FIG. 6. Since the present invention is primarily concerned with graphical user interfaces for viewing and configuring devices in an automated provisioning system, only the GUI portions associated with links 62, 64 and 66 are described in detail herein. Those readers interested in other graphical user interfaces associated with automated provisioning environments are directed to U.S. patent application Ser. No. ______, entitled “Graphical User Interface for Network Management in an Automated Provisioning Environment”, filed on an even date herewith (Attorney Dkt. No. 033048-047) and U.S. patent application Ser. No. ______, entitled “Graphical User Interface for Software Management in an Automated Provisioning Environment”, filed on an even date herewith (Attorney Dkt. No. 033048-048), the disclosures of which are incorporated here by reference.

A user selecting the “View Devices” link 62 at the main menu 60, e.g., by moving a cursor over the link and clicking thereon, can access the “Select Account/DC” menu screen 70 depicted in FIG. 7A. Note that therein, and in subsequent screen shots of an exemplary graphical user interface according to the present invention, various alphanumeric information is blacked out to avoid disclosure of confidential, e.g., customer, information. The blacked out alphanumeric information is not, however, significant to the functionality of the exemplary user interface itself, which functionality is described and claimed herein.

The “Select Account/DC” menu screen provides two levels from which the user can access device information. If the user wants to view devices within a particular data center, e.g., data center 28 in FIG. 4, she or he can open a menu screen (not shown) identifying devices and/or customer compartments by selecting that data center's corresponding link within this menu 70. This viewing perspective might be useful to a user of the GUI to view, for example, all of the firewalls in a particular data center to determine the networking impact on moving a firewall from one position to another. Alternatively, if the user wants to view devices associated with a particular customer, then that user can activate that customer's link within menu 70 of the graphical user interface. This leads to another menu 72 being depicted on the user's display, an example of which is illustrated in FIG. 7B. The portion of the graphical user interface depicted in FIG. 7B provides a global reporting interface with a variety of information useful, e.g., to customer engineers or project managers, to determine the status and makeup of their web site infrastructure. For example, each device is identified by (taking the columns from left to right) an identifier for the data center (DC) within which it physically resides, the service(s) which it supports, its use/state, its operating system (OS) role, its application (App) role, its customer role, its effective beginning date and physical location within the data center.

The use/state field provides the GUI user with information regarding how each device is being used within that customer's infrastructure, e.g., the “embryo” use refers to a machine that is prepared for use as a device within a particular customer's infrastructure, but does not currently have the customer's own, e.g., business logic software, loaded thereon. The “staging” use refers to a device that is used to, for example, test a customer's software before it is placed into production. Other uses, not explicitly shown in FIG. 7B may also be used, for example state can also take the value of “production” and “internal”. The use value of a device can be used by the automated framework to determine how to perform various tasks, e.g., what types of device monitoring functions need to be performed for that device.

Similarly, the state value provides other information regarding the operational status of a device. For example, the state value can be any one of “ok”, “decommmissioned”, “unreachable”, and “offline”. The decommissioned state indicates that the device has been taken out of service and, for example, returned to the manufacturer for repair. The unreachable state indicates that, referring again to the automated provisioning framework described above with respect to FIG. 5, the provisioning network 31 cannot communicate with the agent 36 associated with that particular device. The offline state is similar to the unreachable state, but reflects that the inability of the provisioning network 31 to communicate with the agent 36 is due to the fact that the device has been purposefully taken offline for, e.g., maintenance such as replacing parts.

To provide flexibility and further enhance the repeatability of the process, the concept of “roles” is employed in this portion of the GUI to characterize/classify the software components to be installed on a device. The software components are classified into three types of roles that can be related to the frequency with which those components are likely to change, or be upgraded. An OS role comprises the software which has the lowest probability of being changed during the life cycle of a device. This role consists of the operating system for the device, plus other general software. The next type of role, denoted an APP role, consists of software components that also change relatively infrequently, but perhaps more often than the operating system and the general software. This role comprises the application software that is assigned to a device, in accordance with the tasks that are to be performed by that device. Hence, the programs associated with the web server tier and the application server tier are contained in this role. The third type of role, denoted a Customer role, consists of the software that can change on a regular basis for web site, such as HTML pages, Java server pages (JSP), image files, program instructions (e.g., C++ classes or Java classes) and other static content that is regularly updated by the web site host.

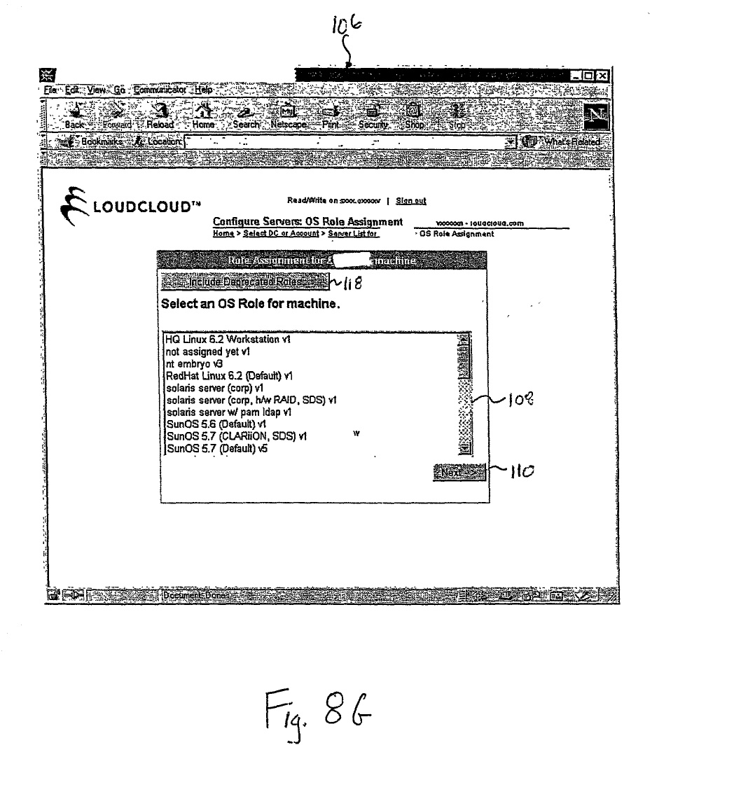

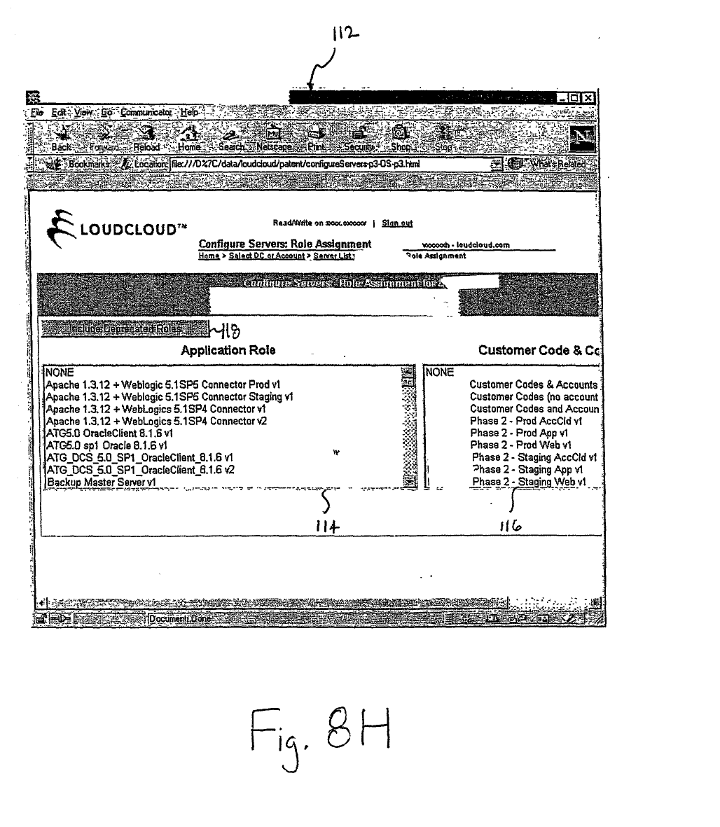

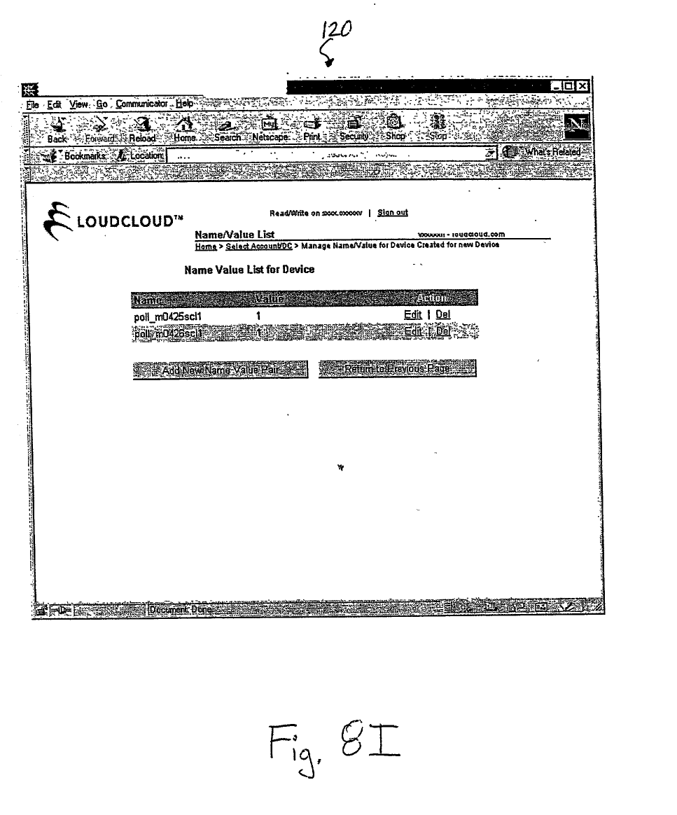

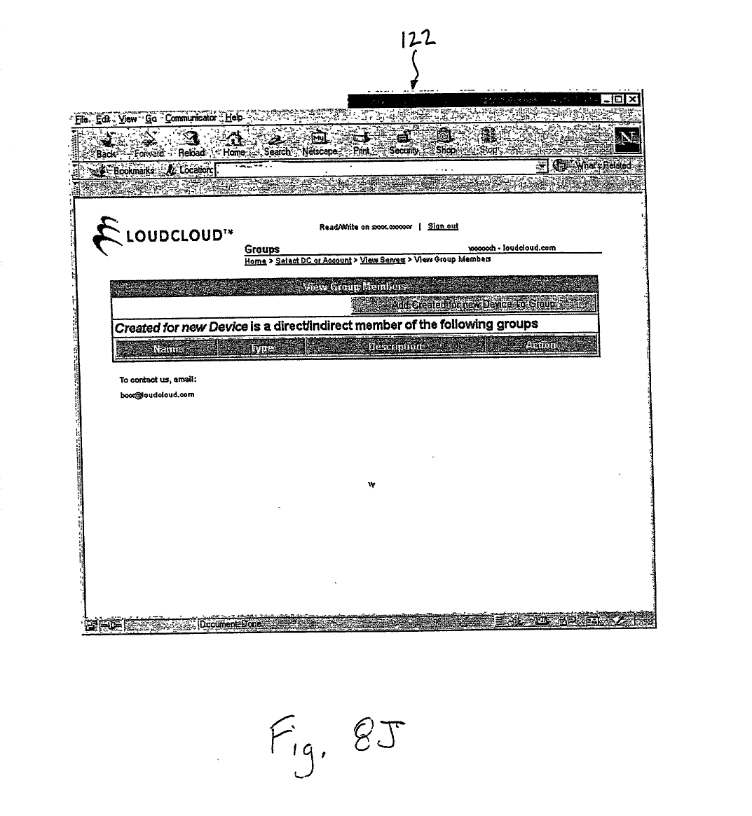

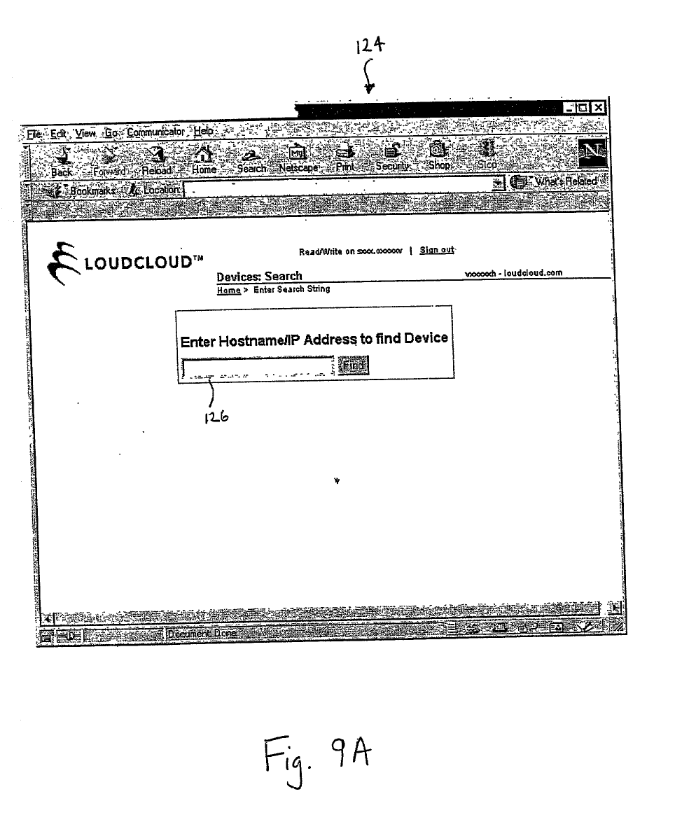

Returning to the main menu 70 of FIG. 6, if the user selects the “Configure Servers” link 64 therein, she or he will again be presented with a menu screen similar to that of FIG. 7A presenting a list of data centers and customers from which subsequent selections can be made, which menu screen 80 is provided as FIG. 8A. To provide a manageable amount of server information, if the GUI user selects a customer having server equipment residing in multiple data centers, then a further selection screen 82 can be displayed, an example of which is provided as FIG. 8B, wherein the user can select a data center in which the previously selected customer has server equipment. Those skilled in the art will appreciate that this data center filter of the displayed server equipment information can be omitted in other implementation of graphical user interfaces according to the present invention, if desired.

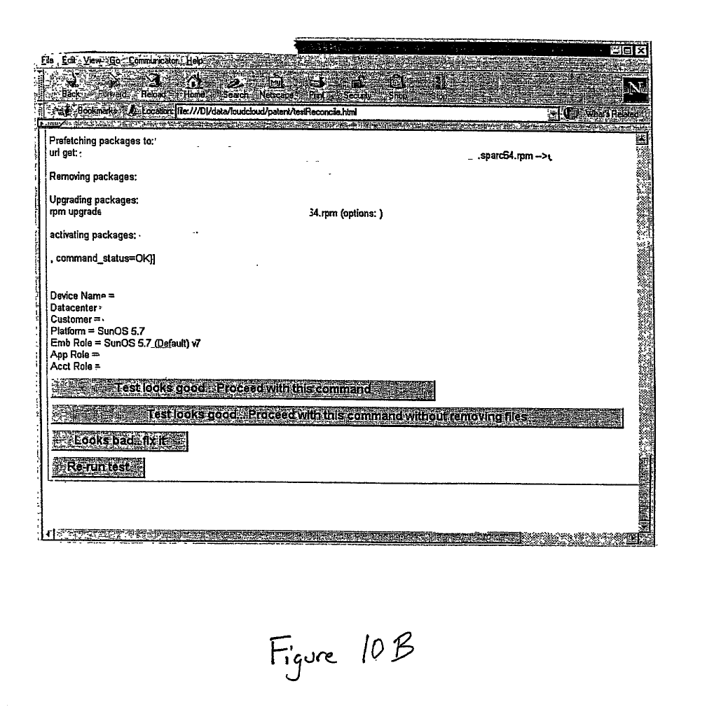

Once the user has selected a customer/data center combination, this exemplary graphical user interface will provide a list of the devices associated with that customer's infrastructure, an example of which is provided as FIGS. 8C and 8D. Therein, the list has been split into a top portion (FIG. 8C) and a bottom portion (FIG. 8D), since the scrollable list in this exemplary GUI is too large for a single screen shot. Beginning from the lefthand side of this screen, the GUI includes checkbox interface objects, e.g., checkbox 86, by way of which a user can select multiple servers for simultaneous configuration. Checkboxes, per se, are well known GUI objects that have the binary state of check or unchecked, which state can be toggled by placing the cursor over the checkbox and clicking the pointing device, e.g., a mouse (not shown). Once the user has selected servers for configuration, using the checkbox elements, the selection links at the bottom of FIG. 8D or any other desired UI mechanism, a configuration action can be defined for the selected device(s) by actuating one of buttons 88, 90 and 92 in FIG. 8D. These buttons implement a “Test Reconcile”, “Change OS Role”, and “Change Application/Customer Role” configuration process, respectively. The Test Reconcile process identifies the software thus far identified for removal/addition and provides the user with the opportunity to proceed or cancel the configuration process. An exemplary Test Reconcile display screen which can be displayed by the GUI in response to actuation of button 88 is depicted as FIGS. 10A and 10B. The Change OS Role process and Change Application/Customer Role process are described in more detail below with respect to the actions available for individual servers.

The “Service” column in FIGS. 8C and 8D provides a mechanism for categorizing each device and can be used in, for example, customer report generation to organize device descriptions for customers regarding their infrastructures. In this exemplary embodiment, the category selected for a particular device can be driven by the application role, described above and also depicted in these Figures, e.g., an application role of “Oracle 8.1.6” translates into a service category of “Database”. The columns for OS Role, App Role and Cust Role provides the user with information regarding the specific roles assigned to each device, which items are described above, and the Use/State of that device. The IP/Hostname indicates the actual IP addresses associated with each device, as well as one or more host names, which information based on, e.g., the number of network cards and the network configuration for that device. The Notes column provides a space for miscellaneous information regarding a device to be recorded.

The Action field permits the GUI user to perform actions on individual devices. Actuating the “View” link in the Action field in screen 84 results in a more detailed display of information associated with that device as exemplified by GUI screen 94 in FIG. 8E. In addition to providing additional information relating to, for example, the CPU, memory, storage capacity and location of the server, this portion of this exemplary GUI according to the present invention also provides the user with a mechanism to change certain server attributes within the system. Specifically, the user can change the use, stage and state attribute values using select/list boxes 96, 98 and 100, respectively. The use and state attributes are described above. The stage attribute can take one of two values, “live” or “in deployment”. Once a server has been provisioned and is up and running in a customer compartment, it can be given a stage attribute value of “live” to trigger other actions within the system, e.g., monitoring processes. Prior to going live, a server will have a stage attribute value of “in deployment”. The select/list box 106 provides the user with the ability to flag a server as “offline” which indicates that this server is undergoing offline maintenance/repair and alerts associated therewith can be safely disregarded. The decommission button 102 permits the user to change the state value to “decommisioned”.

Returning to FIG. 8C or 8D, another action which is available to the user from this screen in exemplary GUIs according to the present invention is provided by the actuable link “OS”. This link permits the user to select or change the OS role for a particular server. When actuated by a user for a device that has a use value of “embryo”, the result is the display of screen 104 in FIG. 8F, which screen indicates that the user should change the use of the server to something other than “embryo”, i.e., since it is being given a role. For servers having a use other than “embryo”, the screen 106 depicted in FIG. 8G will be generated, which screen enables the user to select a particular OS Role using list box 108. Therein, the OS Roles which are available for that customer's servers will be displayed for selection. Selection of one of the OS Roles and clicking on the “Next” button 110 will result in the corresponding operating system being loaded onto that server device. The manner in which the operating system is loaded onto the server can vary depending upon the system architecture, however exemplary techniques for loading one of a plurality of operating systems onto a server are described in U.S. patent application Ser. No. 09/699,330, entitled “Methods and Systems for Installing Software onto Computers” to Raymond Suorsa, filed on Oct. 31, 2000, the disclosure of which is incorporated here by reference.

Frequently, a GUI user that is configuring a new server for addition to a particular customer's infrastructure also knows the application role and customer role to be assigned to a server when the operating system is being loaded therein. Thus, according to exemplary embodiments of the present invention, actuating the “Next” button 110 can also lead to GUI screen 112 depicted in FIG. 8H, wherein the user can the select an application role and a customer role from list boxes 114 and 116, respectively. This portion of the exemplary GUI can also be reached directly from screen 84 using the App/Cust link.

Both screens 106 and 112 include buttons 118 for inclusion of deprecated roles. Deprecated roles refer to roles that have been designated by system operators to be suboptimal, e.g., older versions of software. In their default states, list boxes 108, 114 and 116 will not list deprecated roles for selection. However, there may be instances where a GUI user nonetheless desires that a deprecated role be assigned, e.g., legacy usage of certain software in a particular customer's infrastructure. Accordingly, depressing the deprecated roles button 118 will include those roles in the lists provided in boxes 108, 114 and 116.

Next in the order of actions available from the configure servers screen 84 is the link labeled “Keys”. Actuating this link for a particular server results in the display of a “Name/Value” list as exemplified by screen 120 in FIG. 81. The name/value pairs provide a generic translation mechanism usable for configuration that can be stored in the model stored in database 32. Another configuration interface element provided in the configure servers screen 84 for each device is the actuable link labeled “Groups”. When a user actuates this link, she or he is presented with, for example, the GUI screen 122 in FIG. 8J, wherein that device can be added to a selected group of devices. This GUI functionality permits the user to create and edit sub-groups of customer devices for purposes of, e.g., monitoring or reporting.

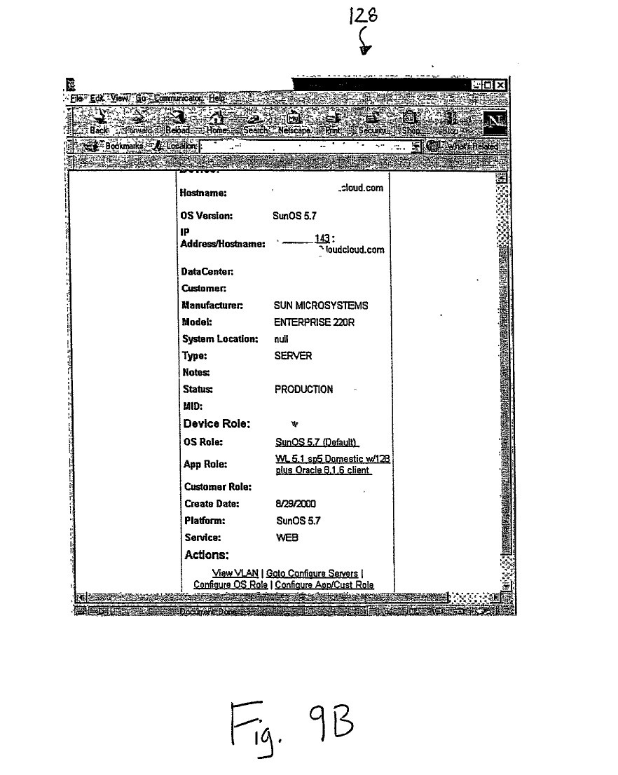

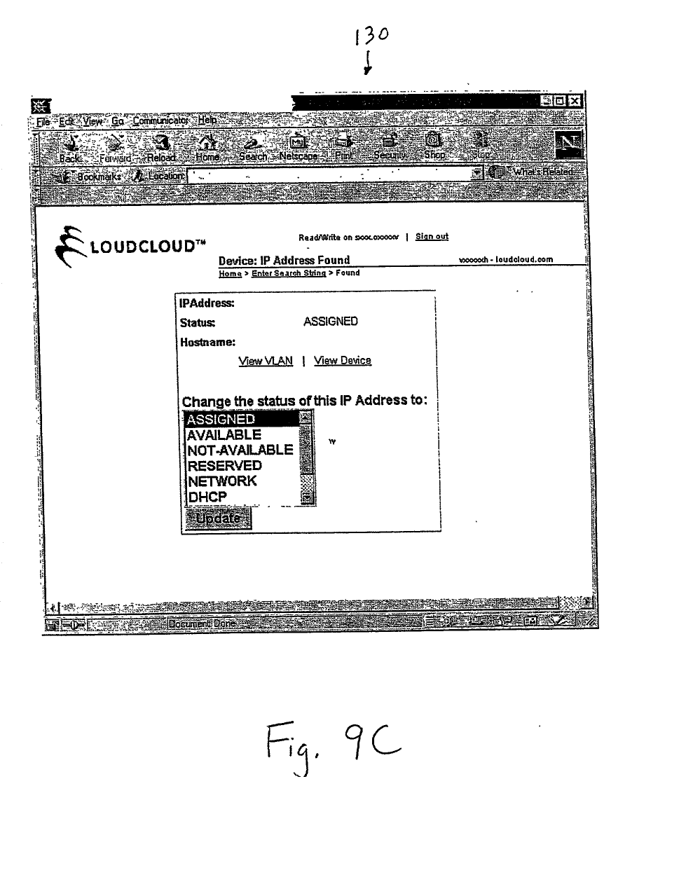

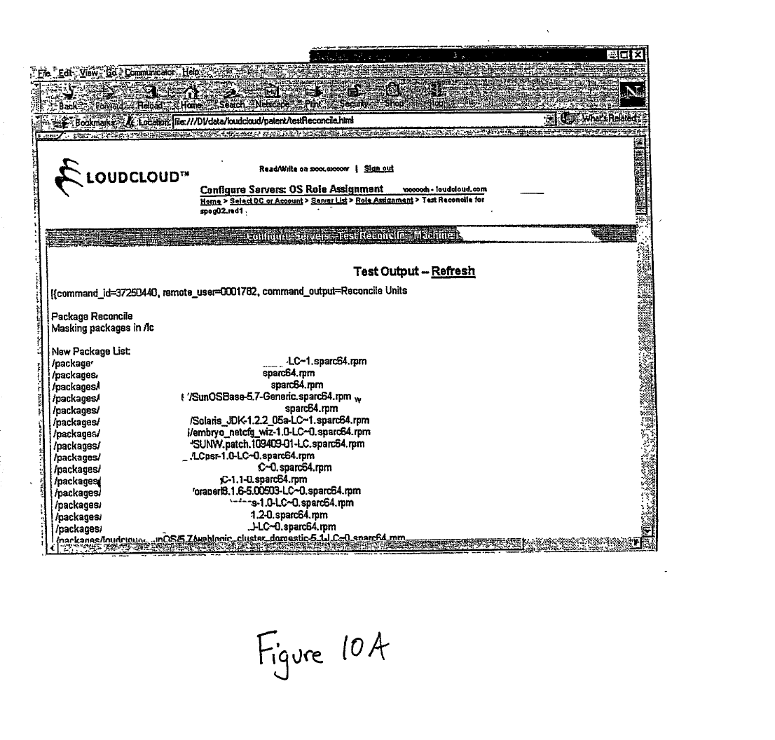

Returning again to the main menu of the exemplary graphical user interface shown in FIG. 6, the third main menu link 66 of interest for describing exemplary embodiments of the present invention is that entitled “Search for Devices”. Not surprisingly, given the scale of a data center which can be populated in a highly automated manner as described above, it will be useful for well versed users to have a mechanism for finding individual devices very rapidly. This can be accomplished by actuating link 66 and moving to screen 124 of the graphical user interface as shown in FIG. 9A. Therein, the user has an opportunity to search for a particular device based on either its hostname or IP address by entering either type of identifier in window 126 and clicking on the “Find” button. If a hostname is entered, the graphical user interface will, in this exemplary embodiment, return a screen 128 of information such as that depicted in FIG. 9B. If an IP address is entered, the GUI user will be presented with a screen 130 such as that shown in FIG. 9C. Therein, the user can view more information associated with the device by clicking on the “View Device” link, which will return the user to screen 128. The user also has the option of changing the state of the IP address manually by selecting an appropriate state and clicking on the “Update” button.

From the foregoing, it will be apparent to those skilled in the art that graphical user interfaces according to the present invention provide an easy and speedy mechanism for operators of automated provisioning systems to access the multitude of data associated with the large number of devices being serviced by the system. These graphical user interfaces also provide a powerful tool for uniform, yet flexible, software installation at a number of different levels, e.g., operating system, application, and customer, for a single device or across multiple devices.

It will be appreciated by those of ordinary skill in the art that the present invention can be embodied in other forms without departing from the spirit or essential characteristics thereof. For instance, while an exemplary embodiment of the invention has been described in the context of provisioning web site servers in a data center, it will be appreciated that the principles underlying the invention can be applied in any environment where computing devices need to be configured and/or updated on a relatively large scale. The foregoing description is therefore considered to be illustrative, and not restrictive. The scope of the invention is indicated by the following claims, and all changes that come within the meaning and range of equivalents are therefore intended to be embraced therein.

What is claimed is:

1. A graphical user interface for viewing a plurality of devices, said graphical user interface comprising:
a first user interface element actuable to access a first portion of said graphical user interface, which first portion displays information associated with a plurality of devices that correspond to a customer, wherein said plurality of devices include at least one of: a server, a firewall, a load balancer and a switch.

2. The graphical user interface of claim 1, wherein said first user interface element is a link which is actuable via a pointing device and a cursor displayed on said graphical user interface.

3. The graphical user interface of claim 1, wherein said first portion of said graphical user interface includes a screen wherein a user can select from a plurality of data centers and a plurality of customers to access said information associated with said plurality of devices that correspond to said customer.

4. The graphical user interface of claim 1, wherein said first portion includes, as said information associated with said plurality of devices that correspond to a customer, at least one IP address associated with each of said plurality of devices.

5. The graphical user interface of claim 1, wherein said first portion includes, as said information associated with said plurality of devices that correspond to a customer, at least one hostname associated with at least some of said plurality of devices.

6. The graphical user interface of claim 1, wherein said first portion includes, as said information associated with said plurality of devices that correspond to a customer, an operating system (OS) role associated with each of said plurality of devices.

7. The graphical user interface of claim 1, wherein said first portion includes, as said information associated with said plurality of devices that correspond to a customer, an application role associated with each of said plurality of devices.

8. The graphical user interface of claim 1, wherein said first portion includes, as said information associated with said plurality of devices that correspond to a customer, a customer role associated with each of said plurality of devices.

9. The graphical user interface of claim 1, wherein said first portion includes, as said information associated with said plurality of devices that correspond to a customer, a use field associated with each of said plurality of devices.

10. The graphical user interface of claim 9, wherein said use field has a value of one of: embryo, staging, production, internal and development.

11. The graphical user interface of claim 1, wherein said first portion includes, as said information associated with said plurality of devices that correspond to a customer, a state field associated with each of said plurality of devices.

12. The graphical user interface of claim 11, wherein said state field has a value of one of: ok, offline, unreachable and decommissioned.

13. The graphical user interface of claim 1, further comprising:
a second user interface element actuable to access a second portion of said graphical user interface, which second portion displays information and configuration user interface elements for each of at least some of said plurality of devices that correspond to said customer.

14. The graphical user interface of claim 13, wherein said at least some of said plurality of devices that correspond to said customer are servers associated with said customer.

15. The graphical user interface of claim 13, wherein said second user interface element is a link which is actuable via a pointing device and a cursor displayed on said graphical user interface.

16. The graphical user interface of claim 13, wherein said configuration user interface elements include a view element which is actuable to reach a configuration screen associated with one of said at least some of said plurality of devices.

17. The graphical user interface of claim 16, wherein said configuration screen includes a use listbox element by which a user can select a use value for a use field displayed in at least one of said first portion and said second portion of said graphical user interface.

18. The graphical user interface of claim 16, wherein said configuration screen includes a use interface element by which a user can select a use value for a use field displayed in at least one of said first portion and said second portion of said graphical user interface.

19. The graphical user interface of claim 16, wherein said configuration screen includes a state interface element by which a user can select a state value for a state field displayed in at least one of said first portion and said second portion of said graphical user interface.

20. The graphical user interface of claim 16, wherein said configuration screen includes a stage interface element by which a user can select a stage value for said one of said at least some of said plurality of devices, wherein said stage value can be one of: live and not live.

21. The graphical user interface of claim 16, wherein said configuration screen provides location information for said one of said at least some of said plurality of devices, said location information including at least one of: a data center identifier, a building identifier, a floor identifier, a cage identifier, a row identifier, a rack identifier and a slot identifier.

22. The graphical user interface of claim 16, wherein said configuration screen includes a user interface element which is actuable to decommission said one of said at least some of said plurality of devices.

23. The graphical user interface of claim 13, wherein said configuration user interface elements include an operating system interface element which is actuable to provide the user with a capability to select an operating system role for one of said at least some of said plurality of devices.

24. The graphical user interface of claim 23, wherein actuation of said operating system interface element results in display of an operating system role assignment screen, from which said user can select an operating system for installation on said one of said at least some of said plurality of devices.

25. The graphical user interface of claim 24, wherein said operating system role assignment screen lists a plurality of different operating systems, with one listing per version of each different operating system.

26. The graphical user interface of claim 25, wherein said operating system role assignment screen includes a user interface element which, when actuated, adds deprecated operating system roles to said list of a plurality of different operating systems.

27. The graphical user interface of claim 13, wherein said configuration user interface elements include an application interface element which is actuable to provide the user with a capability to select an application role for one of said at least some of said plurality of devices.

28. The graphical user interface of claim 27, wherein actuation of said application interface element results in display of an application role assignment screen, from which said user can select an application system for installation on said one of said at least some of said plurality of devices.

29. The graphical user interface of claim 28, wherein said configuration user interface elements include a customer code interface element which is actuable to provide the user with a capability to select an customer role for one of said at least some of said plurality of devices.

30. The graphical user interface of claim 29, wherein actuation of said customer code interface element results in display of a customer role assignment screen, from which said user can select customer code for installation on said one of said at least some of said plurality of devices.

31. The graphical user interface of claim 13, wherein said configuration user interface elements include a name/value interface element which is actuable to permit a user of the graphical user interface to view and operate on name/value pairs associated with one of said at least some of said plurality of devices.

32. The graphical user interface of claim 13, wherein said configuration user interface elements include a group interface element which is actuable to provide the user with a mechanism for assigning one of said at least some of said plurality of devices to a group.

33. A graphical user interface for searching for a device among a plurality of devices within one or more data centers comprising:
an input interface for entering one of a hostname of said device and an IP address of said device; and
a display screen which provides selected information associated with said device based upon whether the input interface received a hostname or an IP address.

34. The graphical user interface of claim 33, wherein said display screen provides an IP address state assignment interface element when said user enters an IP address into said input interface.
